(19) United States
(12) Patent Application Publication
(10) Pub. No.: US 2009/0153472 A1
(43) Pub. Date: Jun. 18, 2009

(54) CONTROLLING A VIEWING PARAMETER

(75) Inventors: Gerrit-Jan Bloem, Eindhoven (NL); Njin-zu Chen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/302,062

(22) PCT Filed: May 15, 2007
(86) PCT No.: PCT/IB2007/051831

§ 371 Date: Nov. 24, 2008

(30) Foreign Application Priority Data
May 31, 2006 (EP) 06114755.9

(51) Int. Cl. G09G 5/00

(52) U.S. Cl. 345/156

(57) ABSTRACT

The invention relates to a method (100) of controlling a viewing parameter for viewing an image on a display for displaying the image, the method comprising a determining step (110) for determining a view of interest within the image, an identifying step (120) for identifying a field of view within the display, a controlling step (130) for controlling the viewing parameter based on the field of view, and a computing step (140) for computing the image based on the controlled viewing parameter and on the field of view, which field of view comprises the view of interest, wherein the field of view is identified using an eye-tracking system for tracking an eye of a user. The method (100) provides a way of controlling the viewing parameter which reduces interruptions in viewing the view of interest. This is particularly useful for a surgeon performing a procedure on a patient using a surgical tool navigation system, when the surgeon needs to adjust a viewing parameter while watching the surgical tool and a surrounding anatomic structure displayed by the navigation system.

### FIELD OF THE INVENTION

This invention relates to a method of controlling a viewing parameter for viewing an image on a display for displaying the image.

The invention further relates to a system for controlling a viewing parameter for viewing an image on a display for displaying the image.

The invention further relates to an image acquisition apparatus comprising said system.

The invention further relates to a workstation comprising said system.

The invention further relates to a computer program product comprising instructions for performing said method when the program product is run on a computer.

### BACKGROUND OF THE INVENTION

Implementations of the method of the kind described in the opening paragraph are known from many image viewing and editing applications, for example from Jasc Paint Shop Pro 7. To control a viewing parameter such as brightness, the user can navigate through the menus to open the Brightness/Contrast control window. This window comprises a text box for typing an increase or a decrease in image brightness. In addition, the Brightness/Contrast control window comprises a control button for increasing brightness, a control button for decreasing brightness, and another button for opening a slider for changing brightness. The control data for controlling a viewing parameter may be entered using a keyboard or a pointer controlled by a mouse or a trackball. An implementation of the method described in U.S. Pat. No. 6,637,883, hereinafter referred to as Ref. 1, employs an eye-tracking system for controlling a viewing parameter. This method also uses a window comprising a Threshold Setting Form for selecting optimum Red-Green-Blue (RGB) threshold settings. The problem with the described implementations of the method is that these implementations require the user to focus the visual attention on a control element such as a text box, a button, or a slider. As a result, the user must temporarily interrupt looking at a view of interest. This is particularly inconvenient to a physician performing a procedure on a patient using a real-time navigation system for navigating a surgical or a diagnostic tool, when the physician needs to interrupt viewing the tool and an anatomical structure displayed by the navigation system in order to adjust a viewing parameter.

### SUMMARY OF THE INVENTION

It is an object of the invention to provide a method of controlling a viewing parameter that reduces interruptions in viewing a view of interest.

This object of the invention is achieved in that the method of controlling a viewing parameter for viewing an image on a display for displaying the image comprises:

a determining step for determining a view of interest within the image;

an identifying step for identifying a field of view within the display, which field of view is identified using an eye-tracking system for tracking an eye of a user;

a controlling step for controlling the viewing parameter based on the field of view; and

a computing step for computing the image based on the controlled viewing parameter and on the field of view, wherein the field of view comprises the view of interest.

The view of interest is determined in the determining step. The term “view of interest” and the acronym “VOI” are used hereinafter to refer to a view which is of interest to a user. The VOI may comprise a view rendered in a predetermined region of the display, e.g. in a region located at the center of the display. The user viewing an image displayed on a display views sharply only a small portion of an image. A region of the display comprising said portion of the display is hereinafter referred to as the “field of view” or the “FOV”. The FOV is identified in the identifying step using an eye-tracking system. A suitable eye-tracking system is described in Ref. 1 and in US2004/0227699. The use of the eye-tracking system is advantageous for a physician performing a medical procedure while viewing the image displayed on the display because controlling a viewing parameter using the eye-tracking system does not require any manual interaction to set the viewing parameter and also preserves a sterile environment. The eye-tracking system may, for example, identify the center of the FOV. Optionally, the size and/or shape of the FOV may be identified. In the controlling step, the value of the viewing parameter is computed based on the FOV, e.g. based on the horizontal coordinate of the FOV center in a system of coordinates of the display. For example, the viewing parameter may be a linear function of said horizontal coordinate of the FOV center. Thus, adjusting the viewing parameter may require the user to look outside the region of the display comprising the VOI, e.g. the region at the center of the display. Therefore, the image computed in the computing step is modified such that the FOV comprises the VOI. For example, a copy of the VOI may be superimposed on the image at the location of the FOV. The method thus provides a control of the viewing parameter which reduces interruptions in viewing the VOI.

In a further implementation of the method, controlling the viewing parameter is further based on an adjustment rate of the viewing parameter. The adjustment rate is the change of the viewing parameter per unit of time, for example per second. In an implementation, the adjustment rate depends on the location of the FOV center on the display. Thus, the value of the viewing parameter changes at the rate associated with the location of the FOV center on the display. In this way, any change in the value of the viewing parameter can be easily obtained.

In a further implementation of the method, a display region for controlling the viewing parameter is associated with the viewing parameter. For example, the viewing parameter associated with a region comprised in the right top quadrant of the display may be brightness. When the FOV is comprised in said region, the brightness is computed on the basis of the location of the FOV in said region. Another display region may be associated with another viewing parameter. Thus, this implementation provides a control of a plurality of viewing parameters without interrupting the viewing of the VOI.

In a further implementation of the method, the computed image comprises a control element for controlling the viewing parameter. An example of such a control element is a control button for increasing image brightness. The control button may be displayed at the top of the image in a control-element region. When the FOV comprises the control button, the image brightness increases at a predetermined rate. In addition, a copy of the VOI is displayed in a region superimposed on the control button comprised in the FOV. Alternatively, the control button may be superimposed on the image viewed by the user. The use of control elements is familiar to most users.

In a further implementation of the method, the computed image is one of a sequence of images for displaying in a cine format. This implementation of the method is especially useful for navigating surgical and diagnostic procedures. For example, a sequence of images, each image showing a surgical or a diagnostic tool in the VOI, may illustrate the tool position and/or the tool orientation during said procedure. This helps the physician in navigating the tool. If the image brightness, for example, needs to be adjusted, the physician can change the image brightness, without manual interaction with a system for controlling the viewing parameter for viewing an image on a display, by looking at the region for controlling the viewing parameter, thus changing the FOV location. According to the method of the invention, the FOV will comprise the VOI, and hence the FOV will depict the tool.

It is a further object of the invention to provide a system of the kind described in the opening paragraphs that reduces interruptions in viewing a view of interest. This is achieved in that the system for controlling a viewing parameter for viewing an image on a display for displaying the image comprises:

a determining unit for determining a view of interest within the image;

an identifying unit for identifying a field of view within the display, which field of view is identified using an eye-tracking system for tracking an eye of a user;

a control unit for controlling the viewing parameter based on the field of view; and

a computing unit for computing the image based on the controlled viewing parameter and on the field of view, wherein the field of view comprises the view of interest.

It is a further object of the invention to provide an image acquisition apparatus of the kind described in the opening paragraphs that reduces interruptions in viewing a view of interest. This is achieved in that the image acquisition apparatus comprises the system for controlling a viewing parameter for viewing an image on a display for displaying the image, the system comprising:

a determining unit for determining a view of interest within the image;

an identifying unit for identifying a field of view within the display, which field of view is identified using an eye-tracking system for tracking an eye of a user;

a control unit for controlling the viewing parameter based on the field of view; and

a computing unit for computing the image based on the controlled viewing parameter and on the field of view, wherein the field of view comprises the view of interest.

It is a further object of the invention to provide a workstation of the kind described in the opening paragraphs that reduces interruptions in viewing a view of interest. This is achieved in that the workstation comprises the system for controlling a viewing parameter for viewing an image on a display for displaying the image, the system comprising:

a determining unit for determining a view of interest within the image;

an identifying unit for identifying a field of view within the display, which field of view is identified using an eye-tracking system for tracking an eye of a user;

a control unit for controlling the viewing parameter based on the field of view; and

a computing unit for computing the image based on the controlled viewing parameter and on the field of view, wherein the field of view comprises the view of interest.

It is a further object of the invention to provide a computer program product of the kind described in the opening paragraphs that reduces interruptions in viewing a view of interest. This is achieved in that the computer program product, to be loaded by a computer arrangement, comprises instructions for controlling a viewing parameter for viewing an image on a display for displaying the image, the computer arrangement comprising a processing unit and a memory, the computer program product, after being loaded, providing said processing unit with the capability to carry out the following tasks of:

determining a view of interest within the image;

identifying a field of view within the display, which field of view is identified using an eye-tracking system for tracking an eye of a user;

controlling the viewing parameter based on the field of view; and

computing the image based on the controlled viewing parameter and on the field of view, wherein the field of view comprises the view of interest.

Modifications and variations of the system, of the image acquisition apparatus, of the workstation, and/or of the computer program product which correspond to modifications of the method and variations thereof as described herein can be carried out by a skilled person on the basis of the present description.

The skilled person will appreciate that the method may be applied to images computed from 2D, 3D, and 4D image data generated by various acquisition modalities such as, but not limited to, conventional X-Ray, Computed Tomography (CT), Magnetic Resonance Imaging (MRI), Ultrasound (US), Positron Emission Tomography (PET), Single Photon Emission Computed Tomography (SPECT), and Nuclear Medicine.

### BRIEF DESCRIPTION OF THE DRAWINGS

These and other aspects of the invention will become apparent from and will be elucidated with respect to the implementations and embodiments described hereinafter and with reference to the accompanying drawings, wherein:

FIG. 1 shows a flowchart of an exemplary implementation of the method;

FIG. 2 schematically shows the field of view;

FIG. 3 illustrates the control of the viewing parameter based on the location of the field of view;

FIG. 4 illustrates a display region for controlling a viewing parameter;

FIG. 5 illustrates two exemplary implementations of the computing of images;

FIG. 6 illustrates an exemplary implementation of the method using two control buttons for controlling image brightness;

FIG. 7 schematically shows an exemplary embodiment of the system;

FIG. 8 schematically shows an exemplary embodiment of the image acquisition apparatus; and

FIG. 9 schematically shows an exemplary embodiment of a workstation.

The same reference numerals are used to denote similar parts throughout the Figures.

### DETAILED DESCRIPTION OF THE EMBODIMENTS

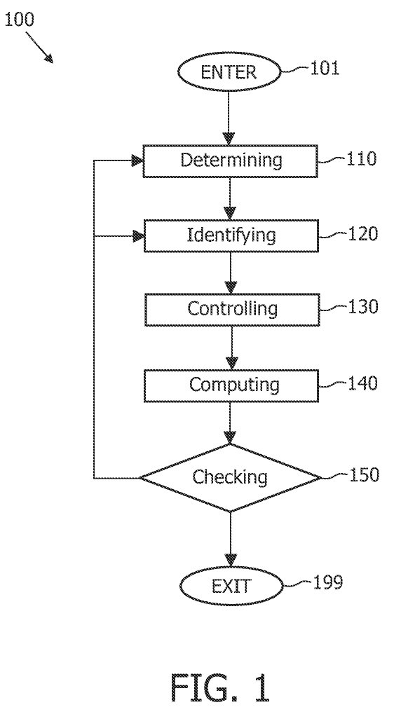

FIG. 1 shows a flowchart of an exemplary implementation of the method 100 of controlling a viewing parameter. After being entered in an entering step 101, the method 100 proceeds to a determining step 110 for determining the VOI. After determining the VOI, the method 100 proceeds to an identifying step 120 for identifying the FOV. The method 100 then proceeds to a controlling step 130 for controlling a value of the viewing parameter. After the controlling step 130 the method 100 proceeds to a computing step 140 for computing an image. The method 100 then proceeds to a checking step 150 for checking whether an exit command is present. If no exit command is present, the method 100 proceeds to the identifying step 120 or to the determining step 110. If an exit command is present, the method 100 proceeds to an exiting step 199 for exiting the method 100.

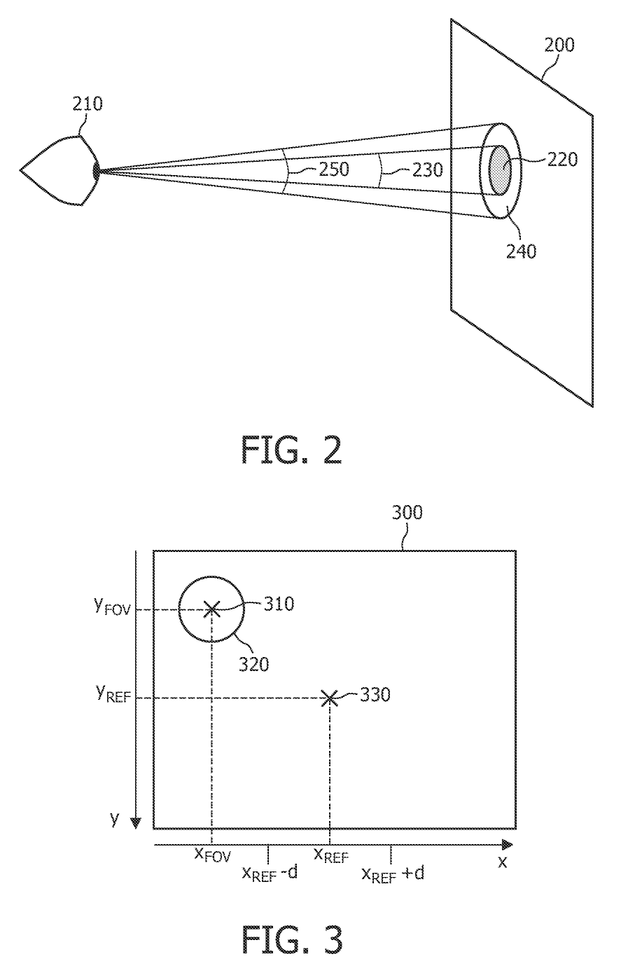

FIG. 2 schematically shows the field of view. When a user 210 is looking at an image displayed on a display 200, only a small portion 220 of the displayed image, which has an optical viewing-range angle 230 of about 2 degrees, is seen sharply in focus. A region 240 of the display comprising this small portion 220 of the displayed image is called the field of view or FOV. The shape and size of the FOV 240 may be arbitrary, for example, the FOV may be a square or an oval comprising the optical viewing range. Typically, the FOV 240 is shaped as a planar circular region. The FOV range angle 250 is typically between 2 and 20 degrees.

A view of interest or VOI is determined in the determining step 110 of the method 100. For example, the VOI may be a region of a medical image displaying a blood vessel examined by the user, e.g. a physician. There are several ways to determine the VOI. The VOI may be determined on the basis of the FOV valid substantially at the moment of entering the method. For example, the VOI may be a view displayed in a predetermined location of the display, e.g. the VOI may be a view to be displayed at the center of the display. The VOI may be determined on the basis of an input from an input device such as, but not limited to, a user input device, a memory, and a processor. For example, the VOI comprising preoperatively acquired images of a surrounding of a catheter may be determined on the basis of an input from a catheter navigating system. The VOI may be computed, for example, by means of image segmentation and/or object detection. These ways of determining the VOI illustrate the implementations of the method 100 and do not limit the scope of the claims.

The FOV is identified in the identifying step 120 of the method 100 using an eye-tracking system. The eye-tracking system may measure the center of the FOV. The eye-tracking system may further measure the angle between the viewing-direction and the display, and/or the distance from the user to the display so as to determine the shape and the size of the FOV. Optionally, a time stamp corresponding to the time of identification of the FOV location may also be determined in the identifying step.

In the controlling step 130 of the method 100 for controlling the a viewing parameter, a value of the viewing parameter is computed based on the FOV. FIG. 3 illustrates the control of the viewing parameter based on the location of the FOV. A display 300 schematically shows the FOV 310 and the FOV center 320. The value of the viewing parameter may be computed on the basis of the position of the FOV center 320 on the display 300. The position of the FOV center 320 may be represented by a horizontal coordinate x_{FOV} and a vertical coordinate y_{FOV} in a display coordinate system with a horizontal x-axis and a vertical y-axis. The reference center 330 is defined by the reference coordinates (x_{REF}, y_{REF}). An example of a location of the reference center 330 is the center of the display 300. Other locations of the reference center may also be useful.

In an implementation of the method 100, the controlled viewing parameter is a function of the horizontal coordinate XFOV of the FOV center 320. For example, the viewing parameter may be a linear function of said horizontal coordinate XFOV, and the value V of the viewing parameter is computed as

V=A×(x_{FOV}−x_{REF})+V_{REF},

where V_{REF} is a reference value of the viewing parameter, which is assumed when x is substantially equal to x_{REF}, and where A is the slope of the linear function determining the range of values of the viewing parameter. The value V_{REF} may be a value of the viewing parameter, which is an optimum in typical viewing conditions.

In a further implementation of the method 100, the viewing parameter depends on the distance of the FOV center to the reference center 330:

V=−B×[(x_{FOV}−x_{REF})²+(y_{FOV}−y_{REF})²]^{1/2}+V_{REF} for y_{FOV}≦y_{REF}, and

V=B×[(x_{FOV}−x_{REF})²+(y_{FOV}−y_{REF})²]^{1/2}+V_{REF} for y_{FOV}>y_{REF},

where B is a constant determining the range of values of the viewing parameter. The skilled person will understand that there are other ways of defining the value V of the viewing parameter as a function of the FOV characteristics, such as shape and/or location.

In a further implementation of the method 100, the control of the viewing parameter is further based on an adjustment rate of the viewing parameter. The adjustment rate is the change of the viewing parameter per unit of time, for example per second. The adjustment rate depends on the position of the FOV center 320. For example, the adjustment rate R may be a function of the horizontal coordinate XFOV of the FOV center 320, e.g. a step function of the horizontal coordinate XFOV of the FOV center 320. A useful definition of the adjustment rate is

R=−R_{c} for x_{FOV}<x_{REF}−d,

R=0 for x_{REF}−d≦x_{FOV}≦x_{REF}+d, and

R=R_{c} for x_{FOV}>x_{REF}+d.

Here R_{c} is a positive constant defining the value of the adjustment rate and d defines a neutral region. When the FOV center is in the neutral region, i.e. when x_{REF}−d≦x_{FOV}≦x_{REF}+d, the value R of the adjustment rate is 0. When x_{FOV}<x_{REF}−d, the value R of the adjustment rate is −R_{c}, and when x_{FOV}>x_{REF}+d, the value R of the adjustment rate is R_{c}. The value of the viewing parameter is further computed on the basis of the time stamp of the position of the FOV center 320 identified in the identifying step 120. For example, the change ΔV in the value V of the viewing parameter may be proportional to the absolute difference Δbetween a time stamp of a first location of the FOV center 320 and a time stamp of a second location of the FOV center 320:

ΔV=R×Δ,

where R is the value of the adjustment rate associated with the current position of the FOV center. The value of the viewing parameter is computed by adding the computed change ΔV to the value V of the viewing parameter.

In yet another implementation, the adjustment rate R may be a linear function of the vertical coordinate y_{FOV}. Here the absolute value of the adjustment rate, i.e. the speed of change of the value of the viewing parameter, is proportional to the distance of the FOV center 320 to the horizontal line through reference center 330. The skilled person will understand that there are other useful functions for computing the value of the viewing parameter on the basis of the adjustment rate and/or on the basis of the FOV location. The described functions illustrate the implementations of the method 100 and do not limit the scope of the claims.

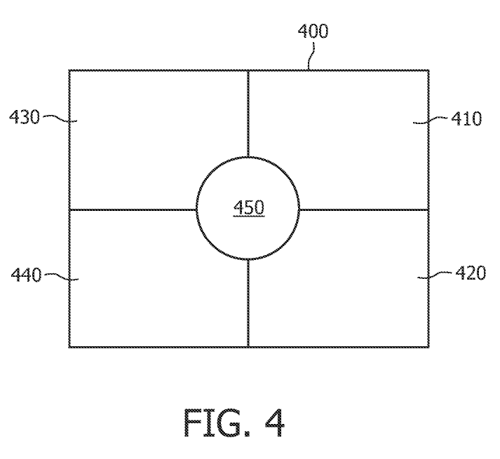

In a further implementation of the method 100, a display region for controlling the viewing parameter is associated with the viewing parameter. Optionally, there may be a plurality of display regions, each display region being associated with a region-specific viewing parameter. Such an exemplary implementation is illustrated in FIG. 4. FIG. 4 illustrates a display region for controlling a viewing parameter. There are five display regions indicated on the display 400. The borders of the regions of the display may be rendered in the rendered image, as is schematically shown in FIG. 4. Alternatively, the borders of the regions may be not rendered. The first region 410 in the top right quadrant of the display 400 is associated with brightness, the second region 420 in the bottom right quadrant of the display 400 is associated with contrast, the third region 430 in the top left quadrant of the display 400 is associated with zoom ratio, and the fourth region 440 in the bottom left quadrant of the display 400 is associated with noise level. A circular neutral region 450 is located in the middle of the display 400. When the FOV center is located in the neutral region 450, the brightness, contrast, zoom ratio, and noise level do not change. When the FOV center is located in the first region 410 of the display 400, the value of image brightness is computed in the controlling step 130. When the FOV center is located in the second region 420 of the display 400, the value of image contrast is computed in the controlling step 130. When the FOV center is located in the third region 430 of the display 400, the value of zoom ratio is computed in the controlling step 130. When the FOV center is located in the fourth region 440 of the display 400, the value of noise-filtering level is computed in the controlling step 130. The values of a viewing parameter may be computed on the basis of region-specific adjustment rates and/or on the basis of the location of the FOV on the display 400. For example, an increased value of brightness based on a positive adjustment rate may be computed when the FOV center is located in a top part of the first region 410, and a decreased value of brightness based on a negative adjustment rate may be computed when the FOV center is located in a bottom part of the first region 410

In an implementation of the method 100, the value of the viewing parameter is modified when the ratio of overlap of the FOV by the respective display region is greater than 0.75. In another implementation of the method 100, the value of the viewing parameter is modified when the FOV fully overlaps the respective display region. The skilled person will understand that other conditions for modifying the viewing parameter may be used. The conditions described above illustrate the method 100 and do not limit the scope of the claims.

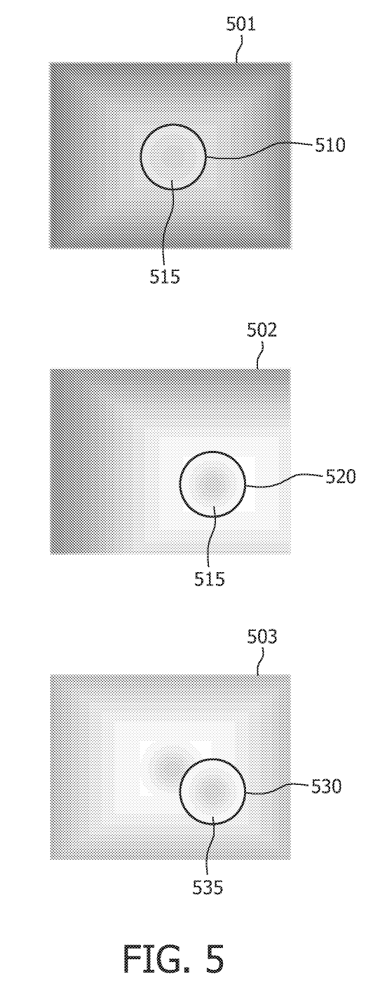

In the computing step 140 of the method 100, an image is computed such that the controlled viewing parameter assumes the value computed in the controlling step 130 and the FOV comprises the VOI. FIG. 5 illustrates two exemplary implementations of the computation of images. The controlled viewing parameter is image brightness. The image brightness is based on the location of the FOV on the display. In the first image 501 computed in the computing step 140, the FOV 510, schematically indicated by a circle, is substantially at the center of the display 501. This location is comprised in a neutral display region. The value of the image brightness is equal to the reference brightness. The FOV 510 is assumed to comprise a VOI 515. In the second image 502 computed in the computing step 140, the FOV 520, schematically indicated by a circle, is near the right bottom corner of the display. This location corresponds to a brightness greater than the reference brightness. Thus, the brightness of the second image 502 is greater than the brightness of the first image 501. The viewing camera determining the second image 502 is translated along with the FOV such that the view comprised in the FOV 520 does not change. Hence, the FOV 520 comprises the VOI 515. In the third image 503 computed in the computing step 140, the schematically indicated FOV 530 is in the same location as in the second image 502, near the right bottom corner of the display. Thus, the brightness of the third image 503, based on the location of the FOV 530, is the same as the brightness of the second image 502 and is greater than the brightness of the first image 501. However, the viewing camera determining the third image 503 is substantially the same as the viewing camera in the first image 501. Instead of moving the viewing camera, the FOV 530 comprises a copy 535 of the VOI 515 superimposed on the image 503.

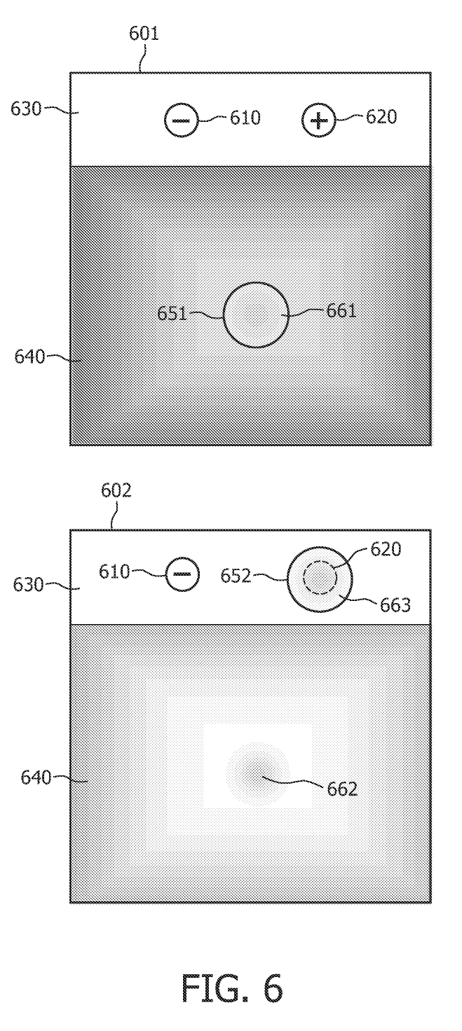

In an implementation of the method 100, the computed image comprises a control element for controlling the viewing parameter. This implementation is schematically shown in FIG. 6. FIG. 6 illustrates an exemplary implementation of the method using two control buttons for controlling image brightness. FIG. 6 shows a first computed image 601 and a second computed image 602. Each image comprises two control buttons, a first control button 610 and a second control button 620. The control buttons are rendered in a control-element region 630 of the display, e.g. at the top of the display. An image data is rendered in the image data region 640 of the display. The first control button 610 serves to decrease the brightness of the image rendered in the image data region 640 and the second control button 620 serves to increase the brightness of the image rendered in the image data region 640.

In the first computed image 601, the schematically indicated FOV 651 is located in the image data region 640. The image data region is a neutral region, i.e. no viewing parameter is controlled by the method 100 when the FOV is located in the image data region. Optionally, when the FOV center 651 is located in the image data region 640, the VOI 661 may be determined on the basis of the FOV 651 in the determining step 110. For example, the VOI 661 may comprise a view comprised in the FOV 651 for a minimum lifetime, e.g. 5 seconds. Optionally, the determined VOI may be rendered in the first control button and/or in the second control button. A control button label may be rendered in the control-element region near the respective button

In the second computed image 602, the schematically indicated FOV 652 is in the control-element region 630 and comprises the second control button 620, schematically indicated by a dashed line, for increasing the image brightness. If the FOV 652 comprises the second control button 620, the image brightness increases at an adjustment rate for increasing image brightness, and a copy 663 of the VOI 662 is rendered in the FOV 652 and superimposed on the second control button 620. If the FOV comprises the first control button 610, the image brightness will decrease at an adjustment rate for decreasing the image brightness, and a copy of the VOI 662 will be shown in the FOV and superimposed on the first control button 610.

The skilled person will understand that other control elements such as, but not limited to, sliders and wheels may be used. The implementations of the method 100 based on using a control element as described above illustrate the invention and should not be construed as limiting the scope of the claims.

Alternatively, the display comprises an image data region and no control-element region. A control element may be rendered in the image data region. Such a control element must be specified, e.g. substantially at the moment of entering the control method in the entering step 101. The entering and specifying of a control button for appearing on the display may be based on a control command, e.g. a voice command such as “start” or “brightness”. A step outside the method 100 may comprise a registration of a voice command. When the “start” command is registered, the entering step 101 is executed and a set of specified control elements is rendered superimposed on a view rendered based on the image data. Typically, the control elements are rendered outside the region comprising a VOI. When the “brightness” command is registered, the entering step 101 is executed and a control element for controlling the brightness is rendered superimposed on a view rendered based on the image data outside the region comprising a VOI. When a “stop” command is detected in the checking step 150, the method proceeds to the exiting step 199. The control buttons disappear after exiting the method.

A control command may be received from a user input device such as, but not limited to, a voice decoder. The user may enter the input using a voice command. Optionally, the command may be received from another input device such as an input device comprising a timer.

The skilled person will understand that there are many useful control commands and that the described examples illustrate the invention rather than limit the scope of the claims.

In an implementation, the method 100 further comprises a checking step 150 for checking whether an exit command for exiting the method 100 is present. If an exit command is present, e.g. in a memory cell read in the checking step 150, the method 100 continues from the checking step 150 to the exiting step 199 for exiting the method 100. If no exit command is present, the method 100 proceeds to the identifying step 120 or to the determining step 110 to start a next monitoring cycle.

In an implementation of the method 100, a command for entering the method 100 is generated when the FOV leaves a neutral region of the display, and a command for exiting the method 100 is generated when the FOV enters the neutral region. This is especially useful for the implementation featuring a control area comprising a control element and an image data region for displaying the image rendered based on image data, as described above. When the FOV is monitored while said FOV moves from the image data region to the control-element region, the method 100 is entered. A step outside the method 100 may comprise a registration of the event of the FOV entering the control-element region. The checking step 150 may comprise checking the FOV location to determine the next step of the method. When the FOV moves from the control-element region to the image data region, the method 100 is exited.

A monitoring cycle comprises steps necessary for computing an image with an adjusted value of the viewing parameter and with the FOV comprising the VOI. In an implementation of the method 100, the monitoring cycle comprises the identifying step 120, the controlling step 130, and the computing step 140. The determining step 110 for determining the VOI is executed once, after entering the method 100 in the entering step 101. Such a monitoring cycle is appropriate when the VOI does not change in the time period from the entering step 101 to the exiting step 199.

In an implementation of the method 100, the monitoring cycle further comprises the determining step 110. This is necessary if the VOI determined in a first monitoring cycle may be different from the VOI in a second monitoring cycle. An exemplary use for this implementation is when the VOI is determined on the basis of an input from a catheter navigation system during an interventional medical procedure such as coronary angioplasty. The determined position of the catheter moving along a blood vessel may be used for displaying views from preoperatively acquired image data to provide guidance for the physician performing the interventional procedure.

In an implementation of the method 100, the computed image is one of a sequence of images for displaying in a cine format. For example, the images from the sequence of images may be computed from planar or volumetric image data in order to provide the user with a movie-like “virtual walk through the image data”, showing views of interest in different locations. Alternatively, the images may be computed from temporally acquired image data in order to provide the user with views of a moving structure at different time moments. An exemplary use of this implementation is in viewing real-time image data for depicting a moving organ, e.g. a heart or an aorta, in a cine format.

The method 100 is useful for controlling viewing parameters of medical images in operating rooms, where an undivided attention of a surgeon conducting a medical procedure is needed. The skilled person will understand, however, that applications of the method 100 to control viewing parameters of other medical and non-medical images are also contemplated.

The order of steps in the described implementations of the method 100 of the current invention is not mandatory, the skilled person may change the order of some steps or perform some steps concurrently using threading models, multi-processor systems, or multiple processes without departing from the concept as intended by the present invention. Optionally, two or more steps of the method 100 of the current invention may be combined into one step. Optionally, a step of the method 100 of the current invention may be split up into a plurality of steps. Some steps of the method 100 are optional and may be omitted.

The method 100, such as the one illustrated by the flowchart diagram in FIG. 1, can be implemented as a computer program product and can be stored on any suitable medium such as, for example, magnetic tape, magnetic disk, or optical disk. This computer program can be loaded into a computer arrangement comprising a processing unit and a memory. The computer program product, after being loaded, provides the processing unit with the capability to carry out the steps of the method 100.

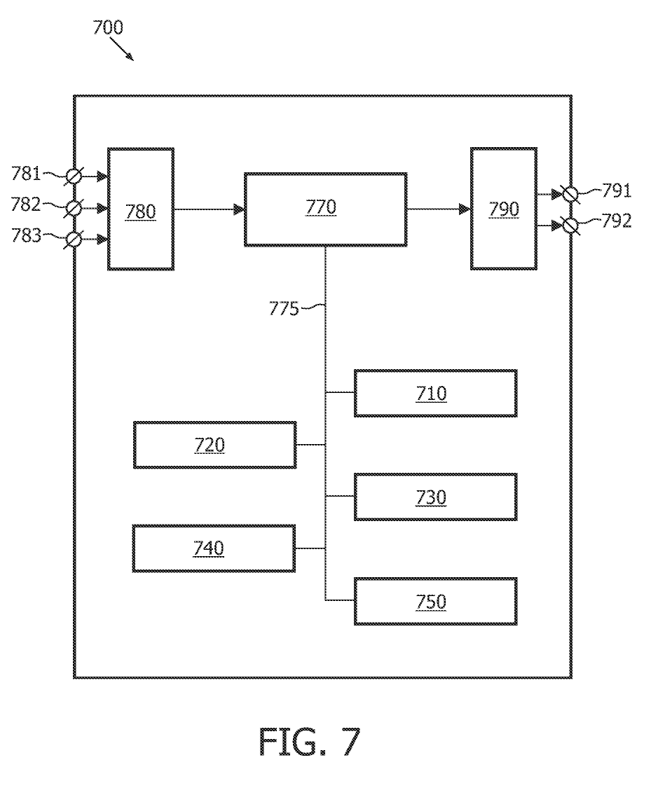

FIG. 7 schematically shows an exemplary embodiment of a system 700 for controlling a viewing parameter for viewing an image on a display for displaying the image, the system comprising:

a determining unit 710 for determining a view of interest within the image;

an identifying unit 720 for identifying a field of view within the display, which field of view is identified using an eye-tracking system for tracking an eye of a user;

a control unit 730 for controlling the viewing parameter based on the field of view; and

a computing unit 740 for computing the image based on the controlled viewing parameter and on the field of view, wherein the field of view comprises the view of interest.

In the embodiment of the system 700 shown in FIG. 7, there are three input connectors 781, 782 and 783 for the incoming data. The first input connector 781 is arranged to receive data coming in from a data storage device such as, but not limited to, a hard disk, a magnetic tape, flash memory, or an optical disk. The second input connector 782 is arranged to receive data coming in from a user input device such as, but not limited to, a mouse or a touch display. The third input connector 783 is arranged to receive data coming in from a user input device such as a keyboard. The input connectors 781, 782 and 783 are connected to an input control unit 780.

In the embodiment of the system 700 shown in FIG. 7, there are two output connectors 791 and 792 for the outgoing data. The first output connector 791 is arranged to output the data to a data storage device such as a hard disk, a magnetic tape, flash memory, or an optical disk. The second output connector 792 is arranged to output the data to a display device. The output connectors 791 and 792 receive the respective data via an output control unit 790.

The skilled person will understand that there are many ways to connect input devices to the input connectors 781, 782 and 783 and the output devices to the output connectors 791 and 792 of the system 700. These ways comprise, but are not limited to, a wired and a wireless connection, a digital network such as a Local Area Network (LAN) and a Wide Area Network (WAN), the Internet, a digital telephone network, and an analog telephone network.

In an embodiment of the system 700 according to the invention, the system 700 comprises a memory unit 770. The system 700 is arranged to receive input data from external devices via any of the input connectors 781, 782, and 783 and to store the received input data in the memory unit 770. Loading the input data into the memory unit 770 allows a quick access to relevant data portions by the units of the system 700. The input data comprise, but are not limited to, the image data. The memory unit 770 may be implemented by devices such as a Random Access Memory (RAM) chip, a Read Only Memory (ROM) chip, and/or a hard disk. Preferably, the memory unit 770 comprises a RAM for storing the input data and/or output data. Optionally, the output data comprise, but are not limited to, a logfile of a viewing session. The memory unit 770 is also arranged to receive data from and deliver data to the units of the system 700 comprising the reading unit 705, the determining unit 710, the identifying unit 715, the computing unit 725, and the computing unit 730 via a memory bus 775. The memory unit 770 is further arranged to make the output data available to external devices via any of the output connectors 791 and 792. Storing the data from the units of the system 700 in the memory unit 770 advantageously improves the performance of the units of the system 700 as well as the rate of transfer of the output data from the units of the system 700 to external devices.

Alternatively, the system 700 does not comprise the memory unit 770 and the memory bus 775. The input data used by the system 700 are supplied by at least one external device, such as an external memory or a processor, connected to the units of the system 700. Similarly, the output data produced by the system 700 are supplied to at least one external device, such as an external memory or a processor, connected to the units of the system 700. The units of the system 700 are arranged to receive the data from each other via internal connections or via a data bus.

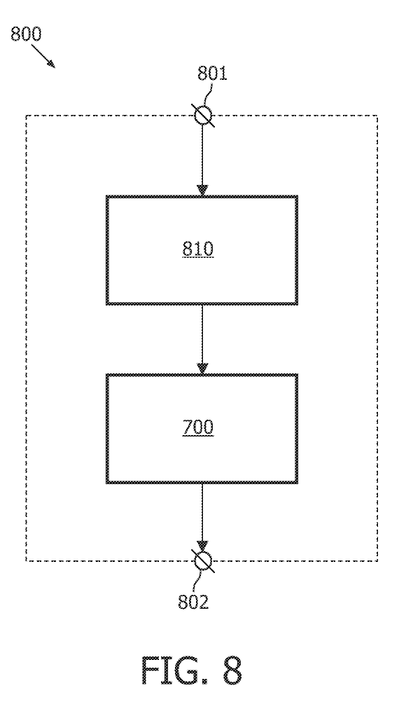

FIG. 8 schematically shows an exemplary embodiment of the image acquisition apparatus 800 employing the system 700, said image acquisition apparatus 800 comprising an image acquisition unit 810 connected via an internal connection to the system 700, an input connector 801, and an output connector 802. This arrangement advantageously increases the capabilities of the image acquisition apparatus 800, providing said image acquisition apparatus 800 with advantageous capabilities of the system 700 for controlling a viewing parameter of the display. Examples of image acquisition apparatuses comprise, but are not limited to, a CT system, an X-ray system, an MRI system, an US system, a PET system, a SPECT system, and a Nuclear Medicine system.

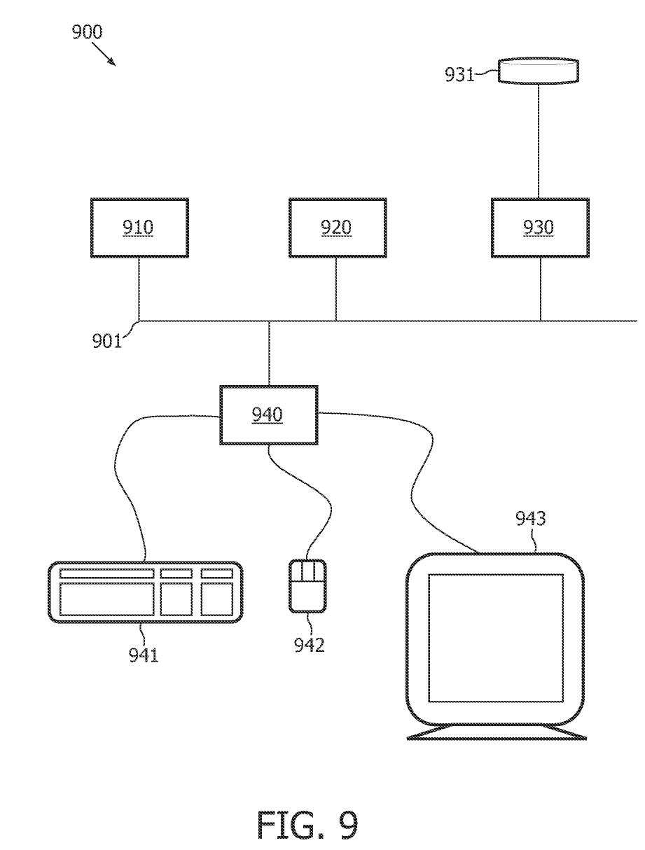

FIG. 9 schematically shows an exemplary embodiment of a workstation 900. The workstation comprises a system bus 901. A processor 910, a memory 920, a disk input/output (I/O) adapter 930, and a user interface (UI) 940 are operatively connected to the system bus 901. A disk storage device 931 is operatively coupled to the disk I/O adapter 930. A keyboard 941, a mouse 942, and a display 943 are operatively coupled to the UI 940. The system 700 of the invention, implemented as a computer program, is stored in the disk storage device 931. The workstation 900 is arranged to load the program and input data into memory 920 and execute the program on the processor 910. The user can input information to the workstation 900 using the keyboard 941 and/or the mouse 942. The workstation is arranged to output information to the display device 943 and/or to the disk 931. The skilled person will understand that there are numerous other embodiments of the workstation 900 known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention can be implemented by means of hardware comprising several distinct elements and by means of a programmed computer. In the system claims enumerating several units, several of these units can be embodied by one and the same item of hardware or software. The usage of the words first, second and third, et cetera does not indicate any ordering. These words are to be interpreted as names.

1. A method (100) of controlling a viewing parameter for viewing an image on a display for displaying the image, the method comprising:
a determining step (110) for determining a view of interest within the image;
an identifying step (120) for identifying a field of view within the display, which field of view is identified using an eye-tracking system for tracking an eye of a user;
a controlling step (130) for controlling the viewing parameter based on the field of view; and
a computing step (140) for computing the image based on the controlled viewing parameter and on the field of view, wherein the field of view comprises the view of interest.

2. A method (100) as claimed in claim 1, wherein the control of the viewing parameter is further based on an adjustment rate of the viewing parameter.

3. A method (100) as claimed in claim 1, wherein a display region for controlling the viewing parameter is associated with the viewing parameter.

4. A method (100) as claimed in claim 1, wherein the computed image comprises a control element for controlling the viewing parameter.

5. A method (100) as claimed in claim 1 wherein the computed image is one of a sequence of images for displaying in a cine format.

6. A system (700) for controlling a viewing parameter for viewing an image on a display for displaying the image, the system comprising:
a determining unit (710) for determining a view of interest within the image;
an identifying unit (720) for identifying a field of view within the display, which field of view is identified using an eye-tracking system for tracking an eye of a user;
a control unit (730) for controlling the viewing parameter based on the field of view; and
a computing unit (740) for computing the image based on the controlled viewing parameter and on the field of view, wherein the field of view comprises the view of interest.

7. An image acquisition apparatus (800) comprising a system (700) as claimed in claim 6.

8. A workstation (900) comprising a system (700) as claimed in claim 6.

9. A computer program product to be loaded by a computer arrangement, comprising instructions for controlling a viewing parameter for viewing an image on a display for displaying the image, the computer arrangement comprising a processing unit and a memory, the computer program product, after being loaded, providing said processing unit with the capability to carry out the following tasks of:
determining a view of interest within the image;
identifying a field of view within the display, which field of view is identified using an eye-tracking system for tracking an eye of a user;
controlling the viewing parameter based on the field of view; and
computing the image based on the controlled viewing parameter and on the field of view, wherein the field of view comprises the view of interest.
